(19) United States
(12) Patent Application Publication
(10) Pub. No.: US 2026/0278266 A1
(43) Pub. Date: Sep. 17, 2026

(54) SYSTEMS AND METHODS OF TABLE PROCESSING FOR RETRIEVAL-AUGMENTED GENERATION

(71) Applicant: PwC Product Sales LLC, New York, NY (US)

(72) Inventors: David Robert RESSEGUIE, Knoxville, TN (US); Santiago DIEZ, Dallas, TX (US)

(73) Assignee: PwC Product Sales LLC, New York, NY (US)

(21) Appl. No.: 19/075,920

(22) Filed: Mar. 11, 2025

(51) Int. Cl. G06F 40/20; G06F 16/3329

(52) U.S. Cl. CPC G06F 40/20; G06F 16/3329

(57) ABSTRACT

A computer-implemented method includes: identifying a plurality of tables in a data source; storing data corresponding to one or more data fields shared by the tables in a first format; receiving a user input at a system having one or more trained language models; determining, using at least one trained language model, based on the user input, whether a set of criteria for searching data in the first format are satisfied; in accordance with determining that the set of criteria are satisfied, identifying, using a trained language model, one or more filtering parameters based on the user input; in accordance with determining that the set of criteria are satisfied, searching, by the system, data stored in the first format using the one or more filtering parameters; receiving the data stored in the first format; and generating an output by a trained language model based on the received data.

### FIELD

This disclosure relates generally to retrieval-augmented generation, and more specifically, to systems and methods of retrieval-augmented generation that leverage tabular data.

### BACKGROUND

Retrieval-augmented generation (“RAG”) is a technique for providing a language model (e.g., a large language model or “LLM”) with relevant information that the model can use to generate a more precise and thorough response to a user input. RAG involves searching or otherwise accessing an external data source, such as a web page or a database, to retrieve information that may be relevant in responding to a user input. This retrieved information can be processed by the language model, along with the user input, so that the language model may generate and return an accurate and effective response.

### SUMMARY

Current methods of RAG involve transforming data into markdown, HTML, or other formats for storage in a vector database that are searchable by a semantic search. However, large tables, which may contain dozens or hundreds of rows with variable and/or nested headers, can present two main challenges with respect to tabular data. First, tables often lack sufficient semantic representation to be effectively searched in a semantic search. Second, automated systems such as language models have difficulties with finding relevant information within a large table for responding to an input. Many data sources (e.g., websites, documents) include tabular data, and these data sources may be incompletely and/or inefficiently searched by systems having trained language models as a result of these shortcomings. These challenges prevent language models from effectively and efficiently utilizing data sources that include tabular data for RAG.

Provided herein are systems and methods of tabular data preprocessing and retrieval for performing RAG that can provide a solution to these shortcomings. A method may involve identifying a plurality of tables in a data source to be preprocessed. The plurality of tables to be preprocessed may be identified based on whether the tables have one or more data fields, such as headers, in common with one or more other tables in the data source. The data source may be, for example, a web page or an external database. Data corresponding to the data fields that two or more tables have in common may be stored in a semi-structured format in a NoSQL database. A benefit of storing the data in a NoSQL database is that the semi-structured format allows for the filtering of the tabular data via the use of keywords that can be found in the shared data fields. Since vector databases are used in most current RAG approaches, storing the shared fields in a NoSQL database instead of a vector database may improve the capabilities of a trained language model to use tabular data when responding to user inputs. Other data from the data source besides the shared fields from the tabular data may be stored in a vector database.

A user input may be received, for example, at a system including one or more trained language models via a user interface. If a trained language model determines that the NoSQL database may contain relevant information, the trained language model may create a query for searching the NoSQL database using filtering parameters derived from the user input. The system may then retrieve the relevant information. If the trained language model determines that the NoSQL database may not contain relevant information, the system may search a vector database and retrieve the relevant information.

By storing tabular data in the NoSQL database and other data from the data source in the vector database during preprocessing, a trained language model may efficiently identify the locations where tabular and non-tabular data may be stored, thus preventing the trained language model from becoming overwhelmed with irrelevant context. Additionally, by storing more semi-structured data (e.g., tabular data) in a NoSQL database and less structured data that is more suitable for a semantic search in a vector database, search and retrieval techniques can be used that are the most efficient for a given format of data. A trained language model may then output a response to the user input that is more complete and more accurate when compared to a conventional RAG technique that utilizes a vector database and semantic searching alone. The systems and methods described herein may thus improve the comprehensiveness and accuracy of language model outputs.

In some examples, a computer-implemented method is provided, including: identifying a plurality of tables in a data source; storing data corresponding to one or more data fields shared by the plurality of tables in a first format; receiving a user input at a system comprising one or more trained language models; determining, using at least one trained language model of the one or more trained language models, based on the user input, whether a set of criteria for searching data in the first format are satisfied; in accordance with determining that the set of criteria are satisfied, identifying, using at least one trained language model of the one or more trained language models, one or more filtering parameters based on the user input; in accordance with determining that the set of criteria are satisfied, searching, by the system, data stored in the first format using the one or more filtering parameters; receiving, by the system, data stored in the first format; and generating an output by at least one trained language model of the one or more trained language models based on the received data.

In some examples, the computer-implemented method includes storing data from a portion of the data source other than the plurality of tables in a second format.

In some examples, the computer-implemented method includes, in accordance with determining that the set of criteria are not satisfied, searching, by the system, the data stored in the second format; and receiving, by the system, the data stored in the second format.

In some examples, determining whether a set of criteria for searching data stored in the first format are satisfied is performed by a first trained language model of the one or more trained language models, and wherein identifying one or more filtering parameters based on the user input is performed by a second trained language model of the one or more trained language models.

In some examples, generating an output based on the received data is performed by a third trained language model of the one or more trained language models.

In some examples, the computer-implemented method includes augmenting the data stored in the first format with data from a portion of the data source other than the plurality of tables.

In some examples, the data stored in the first format is stored in a NoSQL database, and the data stored in the second format is stored in a vector database.

In some examples, the first format is a tabular format, and the second format is an unstructured format.

In some examples, determining whether the set of criteria for searching data in the first format are satisfied includes: determining a type of the user input; and determining whether the type of the user input corresponds to an input type associated with the data stored in the first format.

In some examples, the data source is from a pre-selected repository of data sources.

In some examples, a system is provided, including one or more processors, and memory storing computer program code executable by the one or more processors to cause the system to: identify a plurality of tables in a data source; store data corresponding to one or more data fields shared by the plurality of tables in a first format; receive a user input at a system comprising one or more trained language models; determine, using at least one trained language model of the one or more trained language models, based on the user input, whether a set of criteria for searching data stored in the first format are satisfied; in accordance with determining that the set of criteria are satisfied, identify, using at least one trained language model of the one or more trained language models, one or more filtering parameters based on the user input; in accordance with determining that the set of criteria are satisfied, search, by the system, data stored in the first format using the one or more filtering parameters; receive, by the system, data stored in the first format; and generate an output by at least one trained language model of the one or more trained language models based on the received data.

In some examples, the system is caused to store data from a portion of the data source other than the plurality of tables in a second format.

In some examples, the system is caused to the system is further caused to: in accordance with determining that the set of criteria are not satisfied, search, by the system, the data stored in the second format; and receive, by the system, the data stored in the second format.

In some examples, determining whether a set of criteria for searching data stored in the first format are satisfied is performed by a first trained language model of the one or more trained language models, and wherein identifying one or more filtering parameters based on the user input is performed by a second trained language model of the one or more trained language models.

In some examples, generating an output based on the received data is performed by a third trained language model of the one or more trained language models.

In some examples, the system is caused to augment the data stored in the first format with data from a portion of the data source other than the plurality of tables.

In some examples, the data stored in the first format is stored in a NoSQL database, and the data stored in the second format is stored in a vector database.

In some examples, the first format is a tabular format, and wherein the second format is an unstructured format.

In some examples, determining whether the set of criteria for searching data in the first format are satisfied includes: determining an input type of the user input; and determining whether the type of the user input corresponds to an input type associated with the data stored in the first format.

In some examples, a non-transitory computer readable storage medium storing one or more programs is provided, the one or more programs comprising instructions, which, when executed by a system comprising one or more processors and memory, cause the system to: identify a plurality of tables in a data source; store data corresponding to one or more data fields shared by the plurality of tables in a first format; receive a user input at a system comprising one or more trained language models; determine, using at least one trained language model of the one or more trained language models, based on the user input, whether a set of criteria for searching data stored in the first format are satisfied; in accordance with determining that the set of criteria are satisfied, identify, using at least one trained language model of the one or more trained language models, one or more filtering parameters based on the user input; in accordance with determining that the set of criteria are satisfied, search, by the system, data stored in the first format using the one or more filtering parameters; receive, by the system, data stored in the first format; and generate an output by at least one trained language model of the one or more trained language models based on the received data.

In some examples, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates an exemplary method of retrieval-augmented generation including tabular data preprocessing and retrieval, according to some embodiments.

FIGS. 2A and 2B illustrate an exemplary data source for use in a method of retrieval-augmented generation, according to some embodiments.

FIGS. 3A and 3B illustrate an exemplary user interface, according to some embodiments.

FIG. 4 illustrates an exemplary system, according to some embodiments.

FIG. 5 illustrates a computer, according to some embodiments.

### DETAILED DESCRIPTION

Described herein are systems and methods of tabular data preprocessing and retrieval for performing retrieval-augmented generation (RAG) using one or more trained language models. The systems and methods described herein may improve the efficiency of the search and retrieval of tabular data. By improving a trained language model's ability to leverage tabular data without becoming overwhelmed with irrelevant context, a trained language model's outputs can be made more comprehensive, predictable, and accurate.

In some examples, a method may include identifying a plurality of tables in a data source to be preprocessed. The data source may be, for example, a web page or a document from a corpus of other documents. The data source may include a combination of tabular data, other types of semi-structured or structured data, and unstructured data. Tables may be identified for preprocessing based on a shared data field, for example, a column header that some or all of the tables in the data source have in common. The table may be extracted, and the data corresponding to these shared fields may stored in a first format, for example, as a column in a semi-structured or structured tabular format. Tabular data corresponding to non-shared fields may also be extracted and stored in the same structure as the data corresponding to the shared fields, but in a different column. Non-tabular data from the data source may be stored in second format, for example, an unstructured format. In some examples, the data in the first format may be stored in a NoSQL database, while the data in the second format may be stored in a vector database.

A user input may be received at a system having one or more trained language models, for example, via a user interface. Based on the user input, a trained language model may determine whether a set of criteria for searching data in the first format are satisfied. For example, a trained language model may be trained to associate the tabular data in the data source with common queries about the data. The trained language model may determine whether the type of user input aligns with the types of queries that are commonly associated with the tabular data in the data source, and if the user input aligns, the trained language model may determine that the data in the first format (extracted from the tables in the data source) should be queried. The system may then search the data in the first format using filtering parameters, such as keywords, that are based on the user input, and the results can be provided to the trained language model for responding to the user input.

Alternatively, the trained language model may determine that the user input fails to meet the criteria for searching the data in the first format (e.g., the user input does not align with the types of inputs commonly associated with the tabular data in the data source). Since the data in the first format would thus likely be irrelevant to responding to the user's input, the system may search the data having the second, unstructured format (for example, by performing a semantic search in a vector database). In this manner, a trained language model may determine the relevancy of data and the search technique to use for finding and retrieving this data based on the user input.

The data that is determined to be relevant to responding to the user input may be retrieved by the system, processed by the trained language model, and provided as an output to the user. The output may be displayed at a user interface. The output may include, for example, natural language as well as identifying information corresponding to the data source from which the language model obtained the information. This output provided to the user may be more comprehensive and accurate when compared to language model outputs resulting from existing methods, since the trained language model is used to pinpoint the relevant information for responding to the user input and is not overwhelmed with irrelevant context.

In the following description of the various embodiments, it is to be understood that the singular forms “a,” “an,” and the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

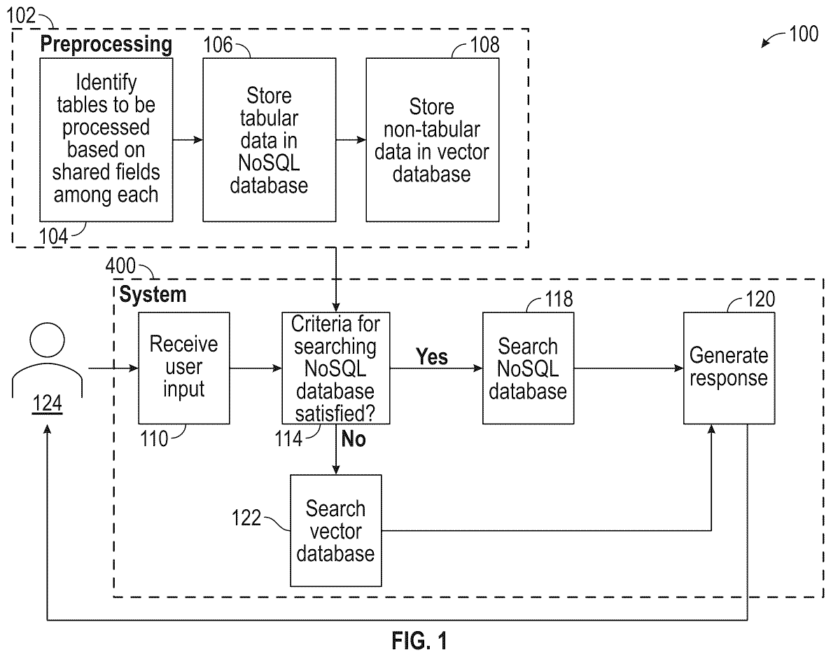

FIG. 1 illustrates an exemplary method of retrieval-augmented generation 100, according to some embodiments. As shown, method 100 may include a preprocessing stage 102 which has a goal of extracting, formatting, and storing tabular data to make it more easily searched by a system comprising a language model. At step 104, method 100 may include identifying, from a data source, different tables for preprocessing. The data source may be a web page, a document, and/or part of pre-existing corpus or repository of data sources that may be updated periodically.

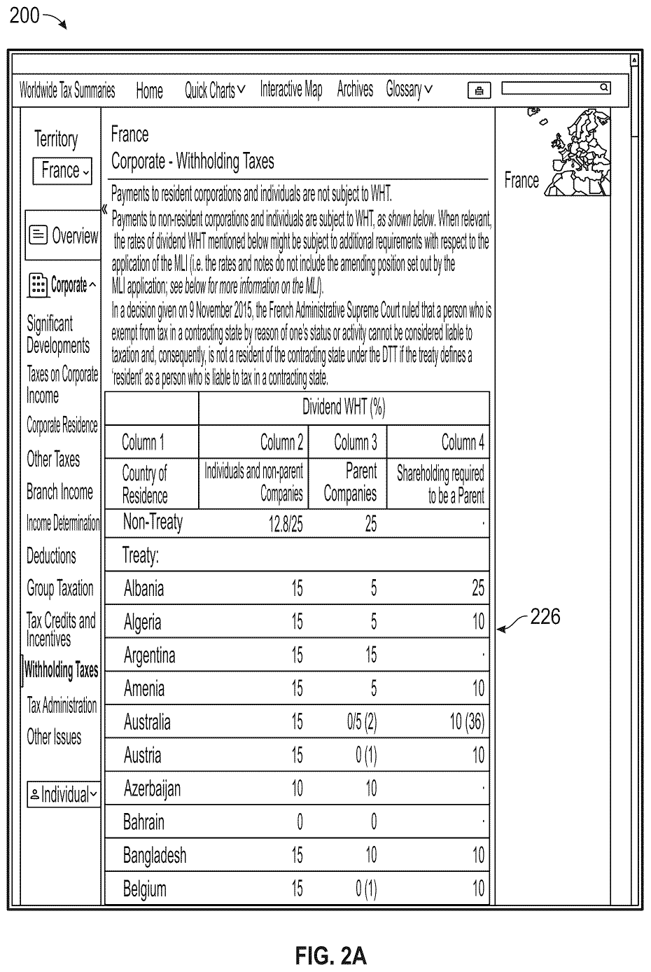

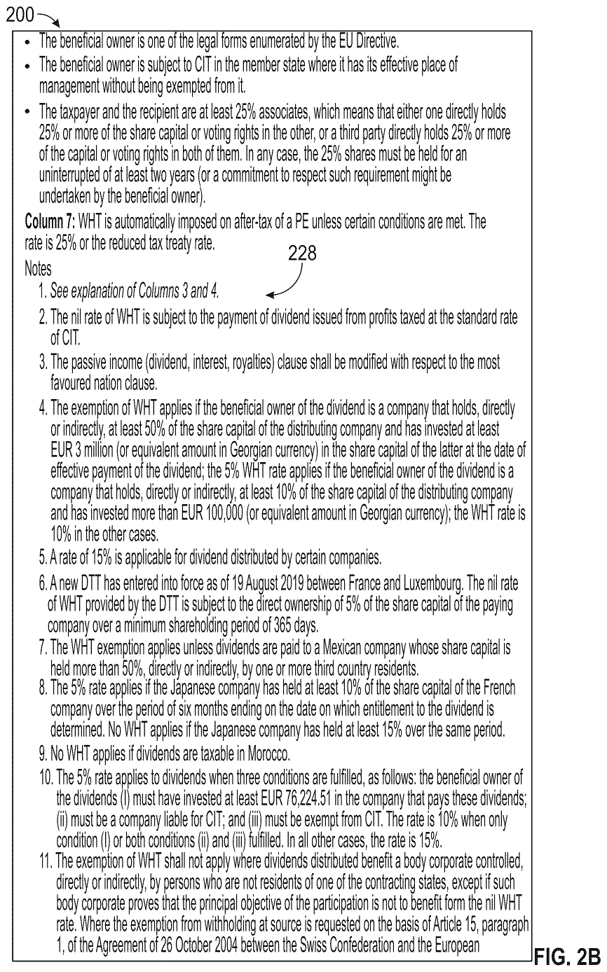

An exemplary data source 200 is shown in FIGS. 2A and 2B. As shown in FIG. 2A, the data source 200 is a web page that may include tabular data 226. FIG. 2B, showing the same data source 200 but scrolled further down the page, depicts how data source 200 may also include non-tabular data 228 (e.g., a numbered or bulleted list, a footnote, etc). Turning back to FIG. 1, step 104 may involve identifying tables from the data source that are to be preprocessed for use in RAG. The tables to be processed may be identified in accordance with various characteristics that may be configurable by a backend user or system administrator. For example, tables that share one or more data fields with one or more other tables may be identified for preprocessing. As used herein, a “shared” data field refers to a data field that two or more tables have in common, such as a matching column header or row label. The shared data field may also be directed to a concept that users tend to use when formulating their inputs. For example, the table in FIG. 2A includes a column header that says “country of residence.” A backend user may configure a system implementing method 100 to identify all tables in a data source that have a “country of residence” header as part of step 104 since many users may want to perform a search by country. Alternatively, tables may be identified for preprocessing based on another characteristic, such as table size (e.g., number of rows and/or columns), the types of data presented in the table (e.g., text data vs. numerical data, particular units, etc.), or by other shared concepts. A benefit of using a shared field is that it allows for tables to be filtered by keywords or patterns that are specific to that field.

Once the tables having the shared data fields have been identified, data corresponding to the shared data fields may be extracted along with additional data (e.g., un-shared fields from the same table or a different table, non-tabular data) from the data source. Then, data from each of the extracted shared fields may be combined and structured in a first format (e.g., as a column in a tabular data structure). A backend user may optionally choose to configure the system to augment this data structure with additional data from one or more unshared data fields. For example, the data structure may be augmented with additional columns that include tabular data from an unshared data field (e.g., information located in an unshared row, column, or cell, and/or information located in a footnote). Data from the extracted tables that is in an unshared data field can be formatted as a separate data structure, for example, in a single attribute as a JSON dictionary.

In some examples, only tabular data, including shared data fields as well as fields that are not shared between tables, may be stored in a first structured format in a NoSQL database at step 106. The NoSQL database may be, for example, CosmosDB. Non-tabular data (e.g., data 228 shown in FIG. 2B), on the other hand, may be chunked, embedded, and stored at step 108, optionally in a vector database in an unstructured format. The vector database may be, for example, Azure AI Search. By processing and storing tabular data separately from non-tabular data, a language model may be able to leverage both semantic and non-semantic search techniques more efficiently depending on the amount of semantic meaning that can be assigned to the data. Although only NoSQL and vector databases are shown and described, other storage options may be used, and information from the data source may be allocated between any suitable number of storage locations. In some examples, tabular and non-tabular data may be stored at different locations locally in memory. For example, Python libraries may be used to store embeddings locally for a vector search, while packages like Pandas can be used to store tables with their corresponding JSON attributes.

At step 110, an input from a user 124 may be received at a system 400. In some examples, the user input may include natural language. System 400 may include one or more trained language models. The one or more trained language models may be any suitable large language model (LLM) such as GPT-3.5-turbo, GPT-4-32k, GPT-4.0, GPT-4-8k, Google Gemini, Claude, Llama, and so on. At step 114, a trained language model in system 400 may determine whether a set of criteria have been met for the data in the first format (e.g., the structured or semi-structured format) to be searched (e.g., whether the NoSQL database should be searched) based on the user input. A language model may have been trained to recognize types of inputs, such as questions or keywords, that are commonly associated with tabular data in the data source or with a user from a user profile. For example, referring back to FIG. 2A, a trained language model may be trained to recognize that most user inputs with respect to data source 200 are directed to withholding rates, and that the withholding rates are a tabular data field in data source 200. The trained language model may determine whether the user input is directed to withholding rates as the initial criteria for searching the NoSQL database. If the user input is directed to withholding rates (or any other preconfigured criteria), the trained language model may determine that the data stored in the first format may be relevant in generating a response, and thus, the trained language model may determine that the NoSQL database should be searched. More generally, a classification LLM may be trained with historical data on inputs commonly leading to searches of the NoSQL database versus the vector database and may use trends or patterns to predict which database will have relevant information for a given user input.

In some examples, the trained language model may determine that the data stored in the first format may not be relevant in responding to part or all of the user input, for example, if the user input is not related to withholding rates. In this case, the trained language model may determine that the unstructured data in the vector database should be searched at step 122, as it is more likely to contain relevant information for responding to the user input. In some examples, determining whether a set of criteria have been met for the data in the first format (e.g., a tabular format) to be searched (e.g., whether the NoSQL database should be searched) may involve determining whether the user input includes one or more keywords that correspond to the shared data fields used to identify the tables to be preprocessed from step 104.

In some embodiments of method 100, a first trained language model may be used for making the initial determination of which database to search at step 114, while a second trained language model may be used to generate the query for searching the database at step 118 or 122. The first language model may provide instructions to a second language model indicating which database(s) should be searched based on whether the criteria were satisfied at step 114. In this manner, an output from a first language model may be used to prompt a second language model to generate a query based on the information that is most relevant for responding to the user input. In some embodiments, a single language model may be trained both to determine the relevant database to search and to generate the query.

If a trained language model determines that the criteria for searching the data stored in the first format have been satisfied at step 114, filtering parameters may be identified for searching the NoSQL database based on the user input. In some examples, a trained language model may be trained to identify the filtering parameters, as shown in FIG. 1. The trained language model may be trained to identify the filtering parameters from a pre-existing set of filtering parameters (for example, a JSON dictionary of key-value pairs), or “identifying” the filtering parameters may also include the trained language model's generation of suitable filtering parameters in a query such as an SQL query. Filtering parameters may be identified based on the user input. For example, a user input may ask the trained language model for the difference between tax withholding rates in two different entities (Entity 1 and Entity 2). A trained language model may identify filtering parameters such as “withholding rate,” “Entity 1,” and/or “Entity 2” based on the user input and may build an SQL query based on the filtering parameters. As shown at step 118, the system (e.g., system 400) may use these filtering parameters to search the NoSQL database. As a result of the search, system 400 may retrieve relevant information from the NoSQL database for the trained language model to use to respond to the user input. The retrieved information may be, for example, a row of information from the data in the first format (e.g., the tabular data structure) that was stored in the NoSQL database.

Alternatively, a trained language model may determine that the criteria for searching the data in the first format has not been satisfied at step 114. For example, if the user input does not align with the types of inputs typically associated with the tabular data in the data source, a trained language model may determine that the relevant information may not be found in the data in the first format stored in the NoSQL database. In response, the system (e.g., system 400) may search a vector database at step 122, using any suitable semantic search technique. For example, the system may transform the user input into vectors, or embeddings, and may perform a similarity search of the vector database using these embeddings. As a result of the system's similarity search, system 400 may receive relevant information from the vector database for responding to the user input. At step 120, the results obtained from the search of the NoSQL and/or vector databases may be processed and outputted by one or more of the trained language models to the user. In some examples, a single trained language model may be used to determine which of the databases to search and/or process the retrieved information into an output for the user 124.

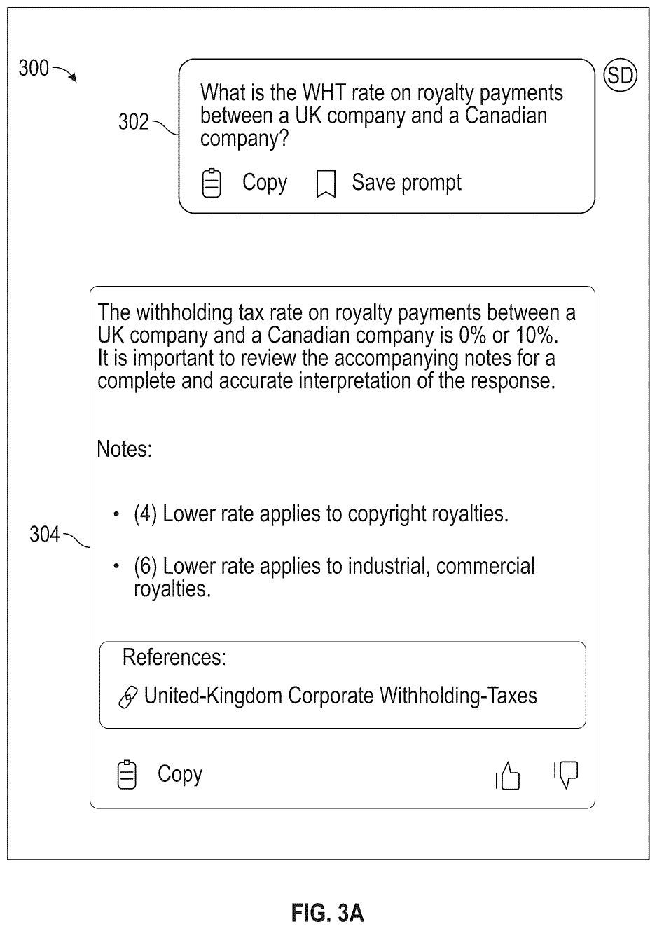

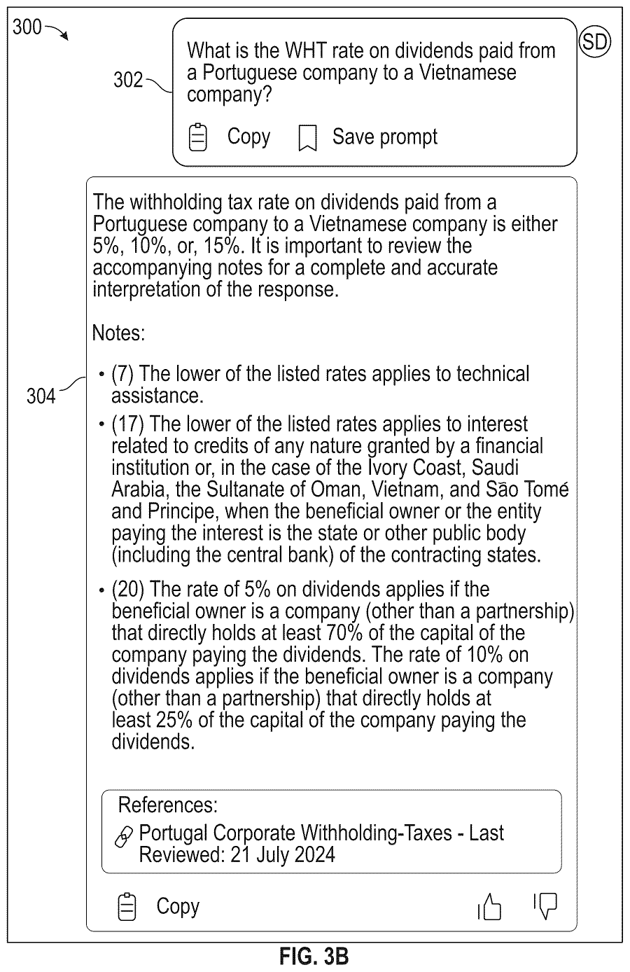

The output may be provided to the user 124 in a user interface. An exemplary user interface 300 is shown in FIGS. 3A and 3B. As shown, a user input 302 may be displayed, followed by a trained language model output 304. In some examples, user interface 300 may be a “chat bot” interface such that a user may type their input into a chat box or a search bar in natural language. The user input 302 may also be provided as a speech input. In FIG. 3A, the user input relates to a withholding tax rate on royalty payments between a UK company and a Canadian company. In this example, a trained language model on the backend may identify filtering parameters such as “withholding tax rates” “royalty payments,” “UK,” and/or “Canada” for searching the NoSQL database or the vector database. In FIG. 3B, the user input relates to a withholding tax rate on dividends paid from a company in Portugal to a company in Vietnam. In this example, a trained language model on the backend may identifying filtering parameters such as “withholding tax rates” “Portugal,” and/or “Vietnam.”

In some examples, a trained language model (e.g., the same model that determines which database to search) may be able to determine whether the user is asking an impermissible question (e.g., whether the answer is highly unlikely to be found in either the NoSQL database or the vector database given the topic of the data source, or whether the input is in an improper or unsupported format). If the user asks an impermissible or completely irrelevant question based on the subject matter stored in either of the databases, the trained language model may provide an output indicating as such to the user instead of providing an output that would cause the system to perform a search. This can help to efficiently utilize computing resources and prevent inaccurate responses.

Depending on if the user input meets the criteria for searching the NoSQL database or not, the system may search either the NoSQL database or the vector database to find an answer for the user. A trained language model may provide the output for display on user interface 300. The displayed output 304 may optionally include notes, which may provide additional information and context for the user to consider. Further, the displayed output 304 may include a list of references, which may include links and/or citations to the data sources that the trained language model relied upon in generating the output. The user may optionally click the links in the list of references to download the information source to their device or to open the information source in a web browser or a separate application.

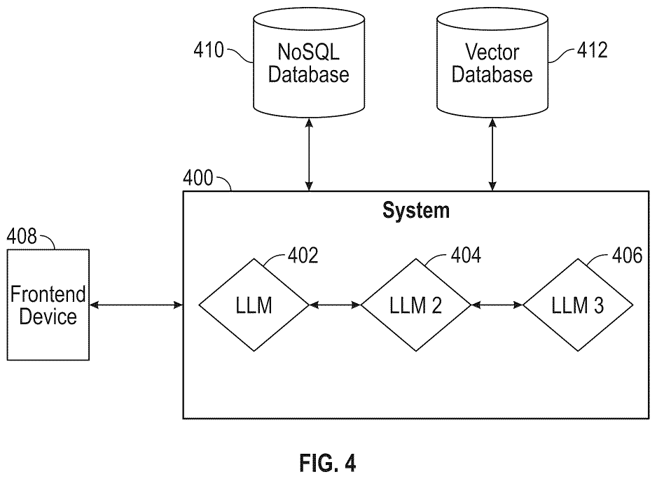

FIG. 4 illustrates an exemplary system 400, according to some embodiments. System 400 may include one or more programs configured with code used to implement one or more steps of the methods described herein. For example, system 400 may include one or more programs configured to receive inputs from, and transmit outputs to, frontend device 408 via an API call over a network. Frontend device 408 may be, for example, a computer, smartphone, or tablet belonging to and/or used by a frontend user. Frontend device 408 may include a touchscreen for touch interaction with a user interface. Frontend device 408 may allow a frontend user to enter inputs into system 400 and to view and edit outputs from system 400. System 400 may also include one or more programs for performing the search functionalities of the system (e.g., for searching the NoSQL database and the vector database). The programming of system 400 may be configured using any suitable programming language, such as C, C #, C++, Python, Rust, Lua, React JS, Node JS, and/or JavaScript.

System 400 may include one or more trained language models 402, 404, 406, which may be large language models (LLMs). LLMs 402, 404, and/or 406 may include, for example, GPT-3.5-turbo, GPT-4-32k, GPT-4.0, GPT-4-8k, Google Gemini, Claude, and/or Llama as described above. LLMs 402, 404, and/or 406 may be in communication with each other, such that outputs from the first LLM 402 may be received as inputs by second LLM 404, and so on. As described, the NoSQL database 410 may be leveraged by the system 400 to store structured, tabular data, while the vector database 412 may be leveraged to store unstructured data. A first LLM (e.g., LLM 402) may be trained to analyze a user input and determine whether the NoSQL database 410 or the vector database 412 should be searched by the system 400. The first LLM 402 may be trained to make this determination based on whether a set of criteria are satisfied, such as whether the user input is of a type that the LLM 402 has been trained to associate with the tabular data in the data source. The first LLM 402 may output the determination of which database to query and may prompt second LLM 404 to create a query to be used by system 400 for searching the database. A third LLM 406 may optionally receive the search results from system 400 and may generate an output that can be provided to frontend device 408. The first LLM 402, the second LLM 404, and/or the third LLM 406 may be in communication with frontend device 408, for example, through API calls back and forth.

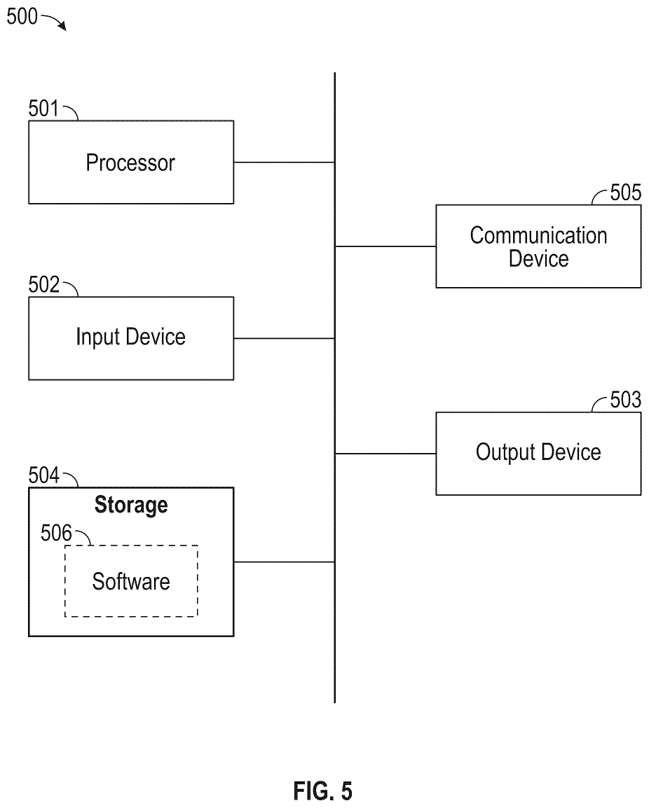

FIG. 5 depicts a computer 500, in accordance with various embodiments. Computer 500 can be a component of system 400 as described herein. Frontend device 408 and/or system 400 may have one or more of the same or similar components as computer 500. Computer 500 can be a host computer connected to a network. Computer 500 can be a client computer or a server. As shown in FIG. 5, computer 500 can be any suitable type of microprocessor-based device, such as a personal computer, workstation, server, videogame console, or handheld computing device, such as a phone or tablet. The computer can include, for example, one or more of processor 501, computer input device 502, output device 503, storage 504, and communication device 505. Computer input device 502 can generally correspond to those described above and can either be connectable or integrated with the computer.

Computer input device 502 can be any suitable device that provides input, such as a touch screen or monitor, keyboard, mouse, or voice-recognition device. Output device 503 can be any suitable device that provides output, such as a touch screen, monitor, printer, disk drive, or speaker.

Storage 504 can be any suitable device that provides storage, such as an electrical, magnetic, or optical memory, including a RAM, cache, hard drive, CD-ROM drive, tape drive, removable storage disk, or other non-transitory computer readable medium. Storage 504 can include one storage device or more than one storage device. As used herein, the terms storage, memory, and/or storage medium/media may refer to singular and/or plural devices which may store data and/or code/instructions individually, redundantly, and/or in cooperation with one another, for example in a local and/or cloud storage environment. Communication device 505 can include any suitable device capable of transmitting and receiving signals over a network, such as a network interface chip or card. The components of the computer can be connected in any suitable manner, such as via a physical bus or wirelessly. Storage 504 can be a non-transitory computer-readable storage medium comprising one or more programs, which, when executed by one or more processors, such as processor 501, cause the one or more processors to execute methods described herein.

Software 506, which can be stored in storage 504 and executed by processor 501, can include, for example, the programming that embodies the functionality of the present disclosure (e.g., as embodied in the systems, computers, servers, and/or devices as described above). In some embodiments, software 506 can be implemented and executed on a combination of servers such as application servers and database servers.

Software 506, or part thereof, can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 504, that can contain or store programming for use by or in connection with an instruction execution system, apparatus, or device.

Software 506 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 500 can implement any operating system suitable for operating the network. Software 506 can be written in any suitable programming language, such as C, C++, Java, or Python. In various embodiments, application software embodying the functionality of the present disclosure can be deployed in different configurations, such as in a client/server arrangement or through a web browser as a Web-based application or Web service, for example.

1. A computer-implemented method comprising:
identifying a plurality of tables in a data source;
storing data corresponding to one or more data fields shared by the plurality of tables in a first format;
receiving a user input at a system comprising one or more trained language models;
determining, using at least one trained language model of the one or more trained language models, based on the user input, whether a set of criteria for searching data in the first format are satisfied;
in accordance with determining that the set of criteria are satisfied, identifying, using at least one trained language model of the one or more trained language models, one or more filtering parameters based on the user input;
in accordance with determining that the set of criteria are satisfied, searching, by the system, data stored in the first format using the one or more filtering parameters;
receiving, by the system, data stored in the first format; and
generating an output by at least one trained language model of the one or more trained language models based on the received data.

2. The computer-implemented method of claim 1, further comprising storing data from a portion of the data source other than the plurality of tables in a second format.

3. The computer-implemented method of claim 2, further comprising:
in accordance with determining that the set of criteria are not satisfied, searching, by the system, the data stored in the second format; and
receiving, by the system, the data stored in the second format.

4. The computer-implemented method of claim 1, wherein determining whether a set of criteria for searching data stored in the first format are satisfied is performed by a first trained language model of the one or more trained language models, and wherein identifying one or more filtering parameters based on the user input is performed by a second trained language model of the one or more trained language models.

5. The computer-implemented method of claim 4, wherein generating an output based on the received data is performed by a third trained language model of the one or more trained language models.

6. The computer-implemented method of claim 1, further comprising augmenting the data stored in the first format with data from a portion of the data source other than the plurality of tables.

7. The computer-implemented method of claim 1, wherein the data stored in the first format is stored in a NoSQL database, and wherein the data stored in the second format is stored in a vector database.

8. The computer-implemented method of claim 1, wherein the first format is a tabular format, and wherein the second format is an unstructured format.

9. The computer-implemented method of claim 1, wherein determining whether the set of criteria for searching data in the first format are satisfied comprises:
determining a type of the user input; and
determining whether the type of the user input corresponds to an input type associated with the data stored in the first format.

10. The computer-implemented method of claim 1, wherein the data source is from a pre-selected repository of data sources.

11. A system comprising:
one or more processors, and
memory storing computer program code executable by the one or more processors to cause the system to:
identify a plurality of tables in a data source;
store data corresponding to one or more data fields shared by the plurality of tables in a first format;
receive a user input at a system comprising one or more trained language models;
determine, using at least one trained language model of the one or more trained language models, based on the user input, whether a set of criteria for searching data stored in the first format are satisfied;
in accordance with determining that the set of criteria are satisfied, identify, using at least one trained language model of the one or more trained language models, one or more filtering parameters based on the user input;
in accordance with determining that the set of criteria are satisfied, search, by the system, data stored in the first format using the one or more filtering parameters;
receive, by the system, data stored in the first format; and
generate an output by at least one trained language model of the one or more trained language models based on the received data.

12. The system of claim 11, wherein the system is further caused to store data from a portion of the data source other than the plurality of tables in a second format.

13. The system of claim 12, wherein the system is further caused to:
in accordance with determining that the set of criteria are not satisfied, search, by the system, the data stored in the second format; and
receive, by the system, the data stored in the second format.

14. The system of claim 11, wherein determining whether a set of criteria for searching data stored in the first format are satisfied is performed by a first trained language model of the one or more trained language models, and wherein identifying one or more filtering parameters based on the user input is performed by a second trained language model of the one or more trained language models.

15. The system of claim 14, wherein generating an output based on the received data is performed by a third trained language model of the one or more trained language models.

16. The system of claim 11, wherein the system is further caused to augment the data stored in the first format with data from a portion of the data source other than the plurality of tables.

17. The system of claim 11, wherein the data stored in the first format is stored in a NoSQL database, and wherein the data stored in the second format is stored in a vector database.

18. The system of claim 11, wherein the first format is a tabular format, and wherein the second format is an unstructured format.

19. The system of claim 11, wherein determining whether the set of criteria for searching data in the first format are satisfied comprises:
determining an input type of the user input; and
determining whether the type of the user input corresponds to an input type associated with the data stored in the first format.

20. A non-transitory computer readable storage medium storing one or more programs, the one or more programs comprising instructions, which, when executed by a system comprising one or more processors and memory, cause the system to:
identify a plurality of tables in a data source;
store data corresponding to one or more data fields shared by the plurality of tables in a first format;
receive a user input at a system comprising one or more trained language models;
determine, using at least one trained language model of the one or more trained language models, based on the user input, whether a set of criteria for searching data stored in the first format are satisfied;
in accordance with determining that the set of criteria are satisfied, identify, using at least one trained language model of the one or more trained language models, one or more filtering parameters based on the user input;
in accordance with determining that the set of criteria are satisfied, search, by the system, data stored in the first format using the one or more filtering parameters;
receive, by the system, data stored in the first format; and
generate an output by at least one trained language model of the one or more trained language models based on the received data.
